(19) United States
(12) Patent Application Publication
(10) Pub. No.: US 2004/0083031 A1
(43) Pub. Date: Apr. 29, 2004

(54) Alcohol sensitive apparatus and method for vehicles

(76) Inventor: Pathfins C. Okezie, Highland Park, NJ (US)

Correspondence Address: Mr. Walter J. Tencza Jr., Suite 3, 10 Station Place, Metuchen, NJ, 08840, US

(21) Appl. No.: 10/426,478

(22) Filed: Apr. 30, 2003

Related U.S. Application Data
(63) Continuation-in-part of application No. 10/282,373, filed on Oct. 29, 2002, now abandoned.

(51) Int. Cl. G06F 17/00

(52) U.S. Cl. 701/1; 340/426.1

(57) ABSTRACT

An apparatus is disclosed comprising a blood alcohol content sensing device which senses that a potential driver of a vehicle has a blood alcohol content above a limit. The blood alcohol sensing device sends a signal which causes operation of the vehicle to be disabled. At least part of the blood alcohol content sensing device may be incorporated into a steering wheel covering. The apparatus may further include a driver visual indicator device which provides a visual indication to the potential driver of the vehicle when the blood alcohol content of the potential driver is above the limit. A telecommunications device may send a communication signal to a monitoring center when the blood alcohol content of the potential driver is above the limit. A blood alcohol content limit for a particular jurisdiction may be transmitted by a transmitter and received by a vehicle.

### CROSS REFERENCE TO RELATED APPLICATIONS

The present application is a continuation in part of and claims the priority of U.S. patent application Ser. No. 10/282,373, filed on Oct. 29, 2002, inventor Okezie.

### FIELD OF THE INVENTION

This invention relates to improved methods and apparatus concerning preventing individuals from drinking and driving.

### BACKGROUND OF THE INVENTION

During the prohibition era in the mid 1920's, Americans built illegal breweries that produced alcoholic drinks such as moonshine so that they could satisfy their thirst for alcohol. Between 1930 and 1937, prohibition was ended. As a result, many more alcoholic breweries sprung up and more and more alcoholic beverages were produced and consumed by motorists and non-motorists alike. In the 1930's, no statistics were kept of the percentage of motorists/motorcyclists involved in vehicular fatalities due to high blood alcohol concentrations or blood alcohol content (BAC). However, it may not be as high as it is today due to the fact that not too many people could afford to buy a car then. Even one fatal crash due to high blood alcohol concentration is one too many. Americans have been dying needlessly after drinking what they enjoy.

Recently, there have been studies that show that moderate intake of red wine and beer, such as once a day can be good for one's health. With studies like this, people go to clubs and social gatherings and they drink alcohol. Most people may not go to these clubs or social gatherings with the intent of getting drunk. However, by the time the these clubs close or by the time these social gatherings end, over fifty percent of the patrons in attendance will have blood alcohol concentration (BAC) in excess of what is permitted by law. Most of the people attending these clubs or social gatherings will drive home by themselves. However, drive drunk and drive others home as well.

When an individual is drunk, their concentration, vision, and reactions are impaired. Often drunk drivers are involved in automobile accidents, which result in fatalities and extensive property damage. Recent statistics, between 1982-2000 of drivers/motorists/motorcyclists involved in fatal crashes by blood alcohol concentration are very disturbing. These statistics show that thousands of American men and women are dying needlessly on our highways. These are future leaders, doctors, lawyers, politicians, and various professionals dying prematurely due to a drunk driver. Our men and women should not be dying on our highways that way. Something has to be done. The statistics are even more disturbing for motorcyclist fatalities. In the year 2000, 2,862 motorcyclists were killed and an additional 58,000 were injured in traffic crashes in the United States as reported in the “National Traffic Safety Fact”. The statistics show that thousands of our men and women are dying needlessly on our highways.

Drunk drivers or operators of other vehicles may also cause fatalities and extensive property damage. For example, the Exxon Valdez oil tanker spill incident was allegedly caused in part due to intoxication.

Studies show that the zero tolerance policy for drugs and alcohol adopted in most companies and government agencies has helped significantly to reduce industrial and office accidents. As you drive through an industrial area, you see some companies proudly display large signs that say, for example, “No industrial Accident for the past 5 years”. These better safety records in industry are attributable to the policy of zero tolerance for drugs and alcohol adopted by these companies. Also most companies and government offices are adopting the policy of “smoke free” office and factory areas. These policies have helped saved lives.

Every day on our highways and local roads, one sees police officers administering sobriety tests on the roadside on motorists suspected of driving under the influence. (DUI)

### SUMMARY OF THE INVENTION

The present invention in one or more embodiments is designed to prevent drivers/operators with any substantial trace of alcohol in their blood from driving a vehicle. The present invention in one or more embodiments will relieve police officers of the duty of performing sobriety tests on suspected motorists on the roadsides. A device is provided in accordance with one or more embodiments, which conducts a sobriety test on a potential driver of a vehicle. If the potential driver fails the sobriety test, the vehicle will not start. If the potential driver passes the sobriety test, then the vehicle will start. The device may conduct a continuous sobriety test, so that if the individual becomes drunk while driving, the engine, for example, may shut off.

An apparatus in accordance with an embodiment of the present invention may be comprised of a blood alcohol content or concentration sensing device, a processor, a memory, a speaker device, a driver visual indicator device, an outward visual indicator device, a telecommunications device, an ignition device, and a microphone device. In operation the blood alcohol concentration (BAC) sensing device will sense a potential driver's blood alcohol concentration. The BAC sensing device will send a signal to the processor, which will specify the individual's BAC. The processor will compare the potential driver's BAC versus a BAC limit, which may be stored in the memory. If the potential driver's BAC is above the limit, the processor will send a signal to the ignition device, which will prevent the potential driver from starting the vehicle.

The processor may also activate the driver visual indicator device and the outward visual indicator device when the processor determines that the potential driver's BAC is above the limit. The driver visual indicator device may be located on the dashboard of the vehicle and would be visible to the potential driver. The outward visual indicator device may be comprised of, for example, one or more lights located on the outside of the vehicle where pedestrians and/or other motorists can see them. The processor may also cause an audio message to play and to be emitted from the speaker device. The processor may send audio signals to the speaker device to cause the message to be played. The audio message may tell the potential driver that his or her BAC is above a legal limit. The processor may also send signals to the telecommunications device to advise a monitoring agency that a potential driver is stranded because he or she has a BAC above the legal limit. The telecommunications device may include a wireless telephone, which may transmit a message to the monitoring agency. The microphone device may allow the potential driver to communicate with the monitoring agency via the processor and/or the telecommunications device.

The present invention, in one or more embodiments, includes a method comprising transmitting a signal providing data specifying a blood alcohol content limit for driving vehicles for a particular jurisdiction. The method may include receiving the signal at a vehicle, determining a driver's blood alcohol content, comparing the driver's blood alcohol content versus the particular jurisdiction's blood alcohol content limit for driving vehicles, and causing operation of a vehicle to cease if the driver's blood alcohol content is greater than the particular jurisdiction's blood alcohol content limit for driving a vehicle. The method may include saving the data specifying the particular jurisdiction's blood alcohol content limit in memory located at the vehicle.

The signal may be transmitted near a border between the particular jurisdiction and another jurisdiction. The particular jurisdiction and the another jurisdiction may be two different states of the United States of America.

The method may further include displaying an indication of the blood alcohol content limit for the particular jurisdiction on a visual display indicator device of the vehicle. The method may further include providing an audible warning to the driver when the signal indicating the blood alcohol limit is received.

The present invention, in one or more embodiments, may include an apparatus comprising a device for receiving a signal, wherein the signal includes data specifying a blood alcohol content limit for driving vehicles for a particular jurisdiction. The present invention may also include a device for determining the blood alcohol content of a driver of a vehicle and a processor. The processor may compare the driver's blood alcohol content versus the particular jurisdiction's blood alcohol content limit for driving vehicles. The processor may cause operation of the vehicle to cease if the driver's blood alcohol content is greater than the particular jurisdiction's blood alcohol content limit for driving a vehicle. The apparatus may be further comprised of memory in which the processor may save the data specifying the particular jurisdiction's blood alcohol content limit for driving vehicles in memory.

### BRIEF DESCRIPTION OF THE DRAWINGS

FIG. 1 shows a block diagram of an apparatus in accordance with an embodiment of the present invention;

FIG. 2 shows a diagram of the location of components of the apparatus of FIG. 1 inside a vehicle;

FIG. 3A shows a block diagram of a monitoring center for use with the apparatus of FIG. 1;

FIG. 3B shows a block diagram of a law enforcement center for use with the apparatus of FIG. 1;

FIG. 4 shows a top view of a vehicle having the apparatus of FIG. 1;

FIG. 5A shows a monitoring center remote control device for use with the apparatus of FIG. 1;

FIG. 5B shows a law enforcement center remote control device for use with the apparatus of FIG. 1; and

FIG. 6 shows a block diagram of an apparatus for transmitting a signal including data specifying a blood alcohol content limit for driving vehicles for a particular jurisdiction.

### DETAILED DESCRIPTION OF THE DRAWINGS

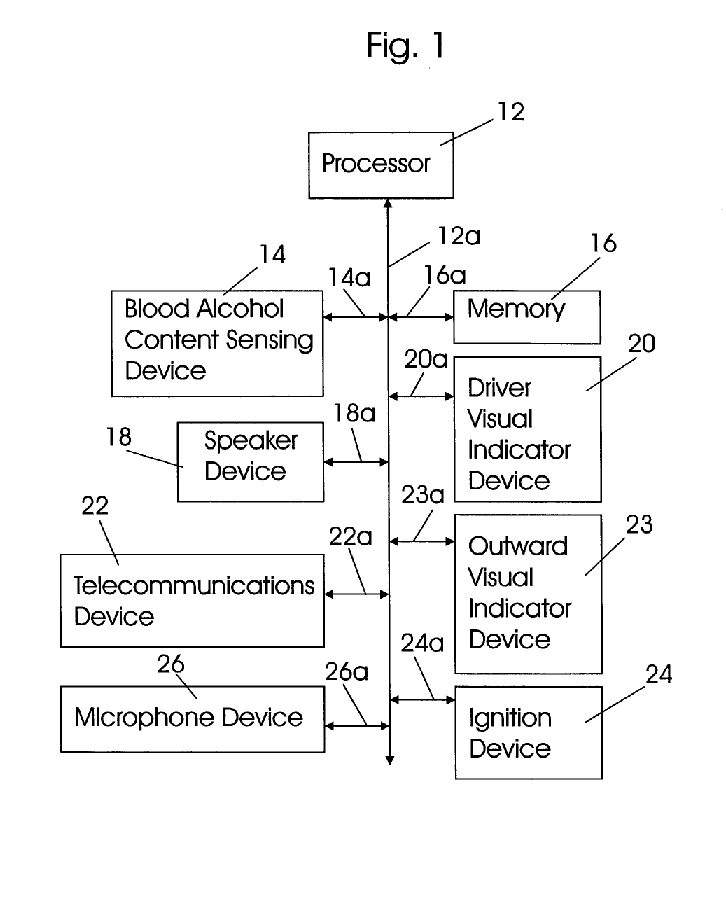

FIG. 1 shows a block diagram of an apparatus 10 in accordance with an embodiment of the present invention. The apparatus 10 includes a blood alcohol content or concentration sensing device 14, a processor 12, a memory 16, a speaker device 18, a driver visual indicator device 20, an outward visual indicator device 23, a telecommunications device 22, an ignition device 24, and a microphone device 26. The sensing device 14, memory 16, speaker device 18, driver visual indicator device 20, telecommunications device 22, outward indicator device 23, ignition device 24, and microphone device 26 communicate with the processor 12 through busses 14a, 16a, 18a, 20a, 22a, 23a, 24a, and 26a, respectively, and through processor bus 12a. Any of the busses may be comprised of any communication connection such as wireless, hardwired, optical, or any other communication connection.

In operation the blood alcohol concentration (BAC) sensing device 14 will sense a potential driver's blood alcohol concentration. The BAC sensing device 14 will send a signal to the processor 12 which will specify the individual's BAC or provide a positive signal to indicate there is at least a trace of alcohol in the potential driver's blood. If a limit is used, the processor 12 will compare the potential driver's BAC versus a BAC limit, which may be stored in the memory 16. If the potential driver's BAC is above the limit, the processor 12 will send a signal to the ignition device 24 which will prevent the potential driver from starting a vehicle such as vehicle 100, on which the apparatus 100 is located.

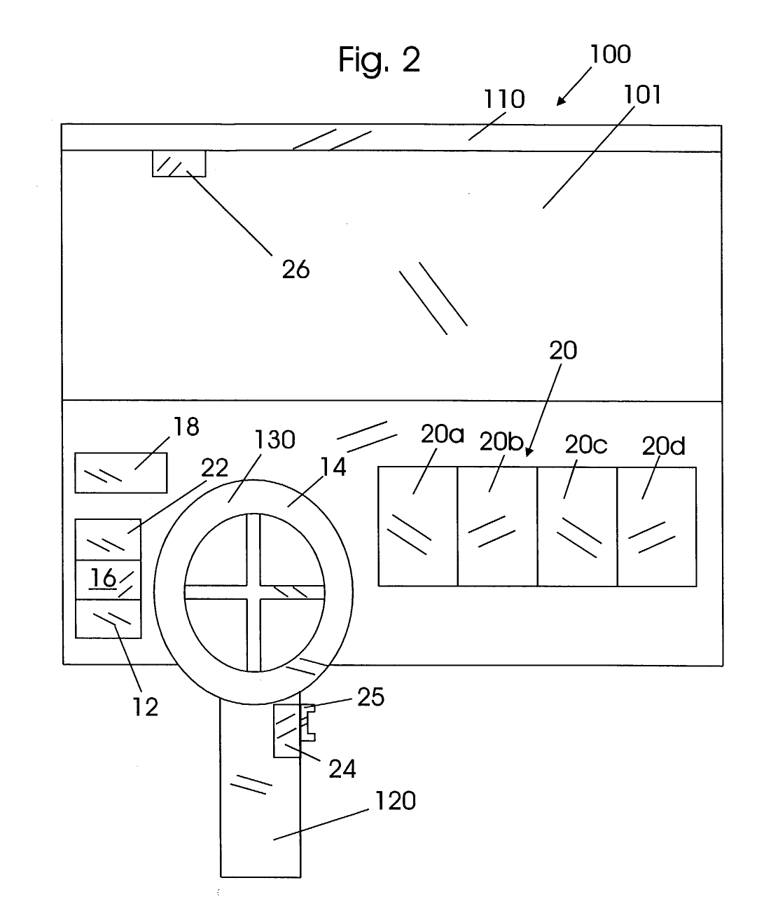

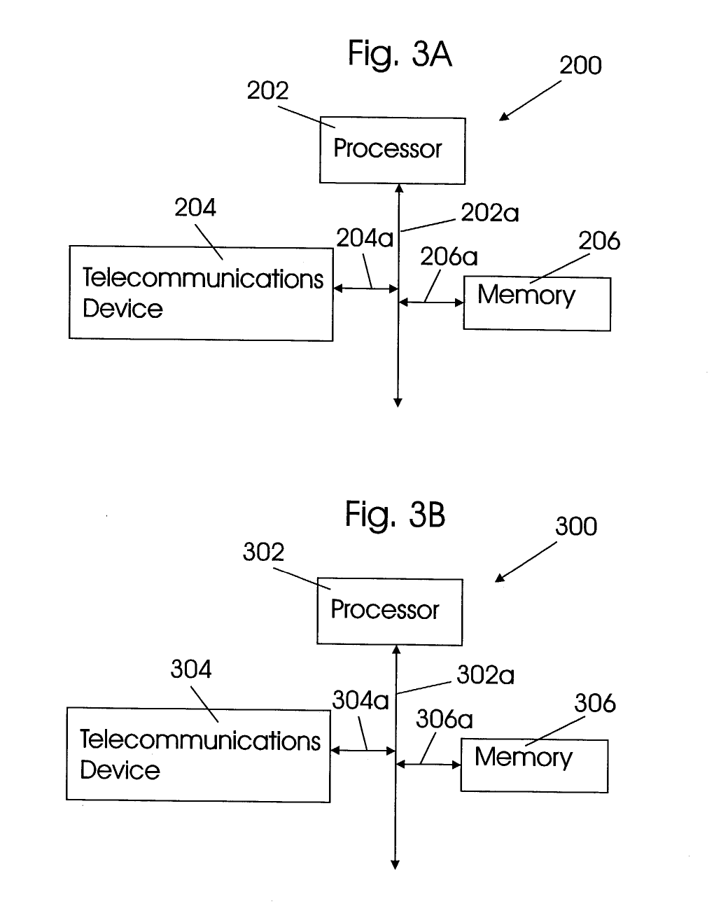

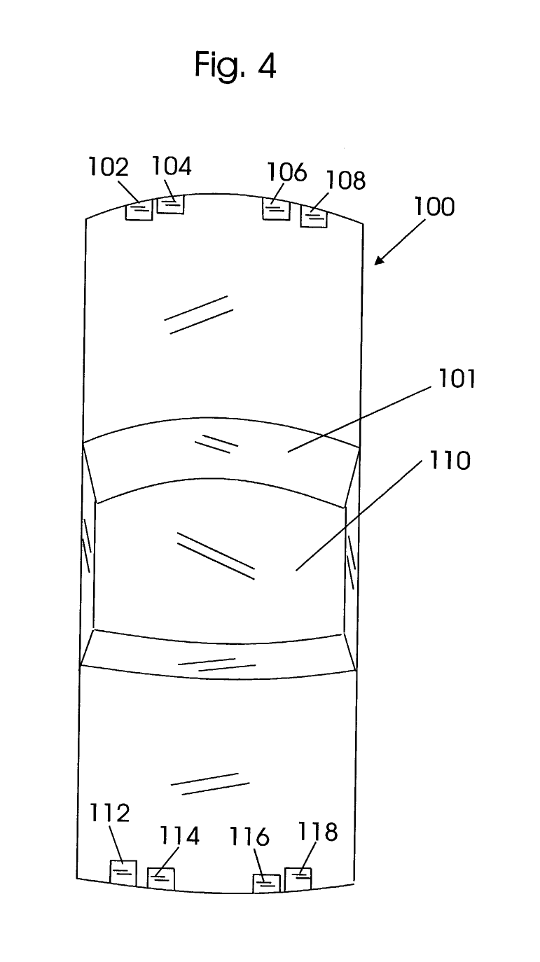

The processor 12 may also activate the driver visual indicator device 20 and the outward visual indicator device 23 when the processor 12 determines that the potential driver's BAC is above the limit. The driver visual indicator device 20 may be located on a dashboard 132, shown in FIG. 2 of the vehicle 100 and would be visible to the potential driver. The outward visual indicator device 23, whose components are shown in FIG. 4, may be comprised of, for example, one or more lights 104, 106, 114, and 116 located on the outside of the vehicle 100 where pedestrians and/or other motorists can see them. The processor 12 may also cause an audio message to play and to be emitted from the speaker device 18. The processor 12 may send audio signals to the speaker device 18 to cause the message to be played. The audio message may tell the potential driver that his or her BAC is above a legal limit. The processor 12 may also send signals to the telecommunications device 22 to advise a monitoring center such as center 200 in FIG. 3A, that a potential driver is stranded because he or she has a BAC above the legal limit. The telecommunications device 22 may include a wireless telephone which may transmit a message to a monitoring center, such as monitoring center 200 shown in FIG. 3A. The microphone device 26 may allow the potential driver to communicate with the monitoring center 200 via the processor 12 and/or the telecommunications device 22.

FIG. 2 shows a diagram of the location of components of the apparatus 10 of FIG. 1 inside the vehicle 100. FIG. 2 also shows a windshield 101, a ceiling 110, a dashboard 132, a steering column 120, and a steering wheel 130 of the vehicle 100. The microphone device 26 can be located inside the vehicle 100 and attached to the ceiling 110. The lights 20a-20d of the driver indicator device 20 may be located on the dashboard 132. The processor 12, memory 16, telecommunications device 22, and speaker device 18 may be located within or be part of the dashboard 132. The steering wheel 130 may include the BAC sensing device 14. The steering column 120 may include the ignition device 24 as well as an ignition switch 25.

FIG. 3A shows a block diagram of a monitoring center 200 for use with the apparatus 10 of FIG. 1. The monitoring center 200 includes a telecommunications device 204 which can be used for communicating with the telecommunications device 22 of FIG. 1. The monitoring center 200 also includes a processor 202 and a memory 206. The telecommunications device 204 and the memory 206 may communicate with the processor 202 via busses 204a and 206a respectively, and through processor bus 202a. The busses 202a, 204a, and 206a may be any type of communication connection such as wireless, hardwired, optical or any other.

The BAC sensing device 14 may be comprised of an absorbent and alcohol sensitive material. The BAC sensing device 14 may be comprised of a patch which is doubly wrapped around the steering wheel 130 of the vehicle 100. The BAC sensing device 14 may detect blood alcohol concentration through a potential driver's bare hands as the potential driver's bare hands rest on and/or firmly grip the steering wheel 130. The BAC sensing device 14 may be comprised of a patch which may be similar to patches which are currently used for monitoring nicotine levels in the blood (cigarette patches) or other patches for monitoring other conditions in the blood (such as birth control patches).

The BAC sensing device 14 may be comprised of a patch which absorbs and/or analyzes the moisture, perspiration, heat, discharge, and/or other variables in the bare hands of a potential driver. The BAC sensing device 14 may be comprised of a device which analyzes the variables in the bare hands for the presence of any trace of alcohol in the potential driver's blood. The BAC sensing device 14 may send a signal of whether it has found any trace of alcohol to the processor 12 or may send a signal indicating the blood alcohol level to the processor 12. The processor 12 may determine whether the signal from the BAC sensing device 14 indicates any trace of alcohol or may determine whether the signal indicates a level above a limit by comparing to a limit stored in the memory 16.

If the processor 12 is programmed for zero tolerance, i.e. any trace of alcohol is unacceptable, then the processor 12 will send a signal to the ignition device 24 to disable the vehicle 100 when the BAC sensing device 14 has sent a signal indicating that at least a trace of alcohol has been detected. The processor 12 may send a signal to the driver visual indicator device 20 when the presence of alcohol has been detected. The processor 12 may thereby cause a message to appear on the driver visual indicator device 20 indicating that alcohol has been detected and that therefore the vehicle 100 has been disabled. Alternatively or additionally the driver visual indicator device 20 may include one or more lights, such a light 20a, which light to indicate that alcohol has been detected and that the vehicle has been disabled.

If the BAC sensing device 14 has provided a positive signal for the presence of alcohol (or presence of sufficient amount above a legal limit) then the processor 12 may send a signal to cause an automatic wireless telephone call to be placed by the telecommunications device 22 to the monitoring center 200. The monitoring center 200 will receive the call through telecommunications device 204.

An operator will be able to receive and/or view the incoming call at the monitoring center 200 through the telecommunications device 204. The operator at the monitoring center 200 will send a non-intoxicated designated driver to drive the vehicle 100 for the potential driver who just failed the sobriety test. The designated driver may driver the potential driver to the potential driver's home or to some location such as the nearest hotel or motel until the potential driver sobers up and/or the alcohol level in the potential driver's blood is reduced below the legal limit or virtually to zero for a zero tolerance situation.

If the BAC sensing device 14 determines that there is no trace of alcohol (or the alcohol level is below a legal limit), i.e. a negative result is obtained to the sobriety test, then the processor 12 may send a signal to the ignition device 24 to permit the vehicle to start and to run.

In one embodiment, as soon as the potential driver sits on the driver/operator seat and puts a key into the ignition key switch 25 of the vehicle 100, and turns the key to attempt to start the vehicle 100, a programmed voice will advise the potential driver to put both bare hands firmly on the steering wheel 130 and to press the steering wheel 130 firmly for a brief sobriety test. The processor 12 may cause the programmed voice to be emitted from the speaker device 18. This sobriety test may only last for a period of ten to fifteen seconds at most. As the potential driver firmly holds the steering wheel 130, the moisture, heat, discharge, chemical secretions, and/or other variables secreted by the potential driver's hands will be received by the BAC sensing device 14 located on the steering wheel 130. If the BAC sensing device 14 and/or the combination of the BAC sensing device 14 and the processor 12 detect a positive result (i.e. a trace of alcohol for zero tolerance or BAC above a legal limit) then the processor 12 will send a signal to the ignition device 24 to disable the ignition device 24 or the ignition device 24 may initially be in a disabled state and the processor 12 may simply not enable the ignition device 24.

FIG. 3B shows a block diagram of a law enforcement center 300 for use with the apparatus 10 of FIG. 1. The monitoring center 300 includes a telecommunications device 304 which can be used for communicating with the telecommunications device 22 of FIG. 1. The law enforcement center 300 also includes a processor 302 and a memory 306. The telecommunications device 304 and the memory 306 may communicate with the processor 302 via busses 304a and 306a respectively, and through processor bus 302a. The busses 302a, 304a, and 306a may be any type of communication connection such as wireless, hardwired, optical or any other.

FIG. 4 shows a top view of a vehicle 100 having the apparatus 10 of FIG. 1. The vehicle 100 includes typical headlights 102 and 108 and typical rear lights 112 and 118, shown in FIG. 4. The vehicle also includes lights 104, 106, 114, and 116 of the outward visual indication device 23.

The driver visual indicator device 20 may be comprised of four blue lights 20a, 20b, 20c, and 20d, whose location is shown in FIG. 2 on a dashboard 132 of the vehicle 100. The processor 12 may send a signal to cause the first blue light 20a to light when the BAC sensing device 14 and/or the processor 12 determine that the potential driver has failed the sobriety test. In addition, the processor 12 may cause front lights 104 and 106, and rear lights 114 and 116 of the outward visual indicator device 23 to light or to blink or toggle on and off when the potential driver has failed the sobriety test. The front lights 104 and 106 may be typical headlights on a car or may be in addition to the headlights 102 and 108 on the vehicle 100. Similarly, the rear lights 114 and 116 may be typical rear lights on a car or may be in addition to rear lights 112 and 118 on vehicle 100.

In addition, when the potential driver fails the sobriety test, the processor 12 may send a signal to activate the microphone device 26 and the telecommunications device 22. The processor 12 may cause the telecommunications device 22 to call the monitoring center 200 and may also allow the potential driver to speak to the monitoring center 200 via the microphone device 26. In this manner, the potential driver can specify his or her exact location to the monitoring center 200. The processor 12 may also send a signal or signals, such as audio signals to the speaker device 18 when the potential driver fails the sobriety test. The audio signals may provide a voice message which lectures the driver on the importance of not driving while intoxicated.

If the vehicle 100 is, or is replaced by, an airplane, the BAC sensing device 14 and/or the processor 12 may be installed on or prior to a cockpit door of the airplane. If a pilot or co-pilot fails a sobriety test, then the cockpit door will not open. However, if the pilot or co-pilot passes the sobriety test, then the cockpit door will open. The processor 12 may also cause the speaker device 18 to play a message, in the form of audio signals, that the potential driver should not try to re-start the vehicle 100. The message may further advise the potential driver that any attempt to restart the vehicle will cause the law enforcement center 300 of FIG. 3B (such as a local police organization) to be called. If the potential driver, nonetheless does try to start the vehicle 100, after failing the sobriety test, the processor 12 will cause the law enforcement center 300 to be called by the telecommunications device 22. The processor 12 may also light the blue light 20b of the driver indicator device 20. Local laws may at least fine potential drivers for attempting to drive a vehicle while intoxicated after receiving a warning not to, from apparatus 10.

The light 20c of the driver indicator device 20 may light when a potential driver refuses to submit to the sobriety test. This could occur, for example, if a potential driver is wearing gloves. The BAC sensing device 14, by examining sweat, heat, discharge or other variables may include a device for determining whether bare hands are contacting the steering wheel 130.

Assuming the potential driver has passed the sobriety test, the BAC sensing device 14 will continue to monitor the potential driver's (now driver's) BAC level. The BAC sensing device 14 and/or the processor 12 will cause a signal to be sent to the ignition device 24 to shut off the engine of the vehicle 100 if at any time the potential driver's (now driver's) BAC level goes above the legal limit or for a zero tolerance situation if a trace of alcohol is found. This avoids the scenario where a non-intoxicated person starts the vehicle, gets out, and then lets an intoxicated person drive. This also avoids the scenario where a non-intoxicated person starts the vehicle, drinks while driving the vehicle, and gradually becomes intoxicated while driving the vehicle.

As an alternative or additionally to shutting off the engine, if at any time the BAC sensing device 14 and/or the processor 12 detects the presence of alcohol above the specified limit then the first blue light 20a of the driver indicator device 20 may turn on and blink and the driver may thus be warned that he/she has tested positive for alcohol and should park immediately. The processor 12 may also cause the speaker device 18 to emit audio signals indicating that the driver has failed the sobriety test and that the driver needs to pull over. If the driver continues to drive the vehicle for a certain length of time, which may be stored in memory 16, after testing positive for alcohol, the processor 12 may cause the engine of the vehicle 100 to shut off in any manner, such as by sending a signal to ignition device 24. There may be a thirty second time period between the warning to park and the shutting off of the engine of vehicle 100. The processor 12 may also cause the law enforcement center 300 to be telephoned via telecommunications device 22 after the thirty-second interval.

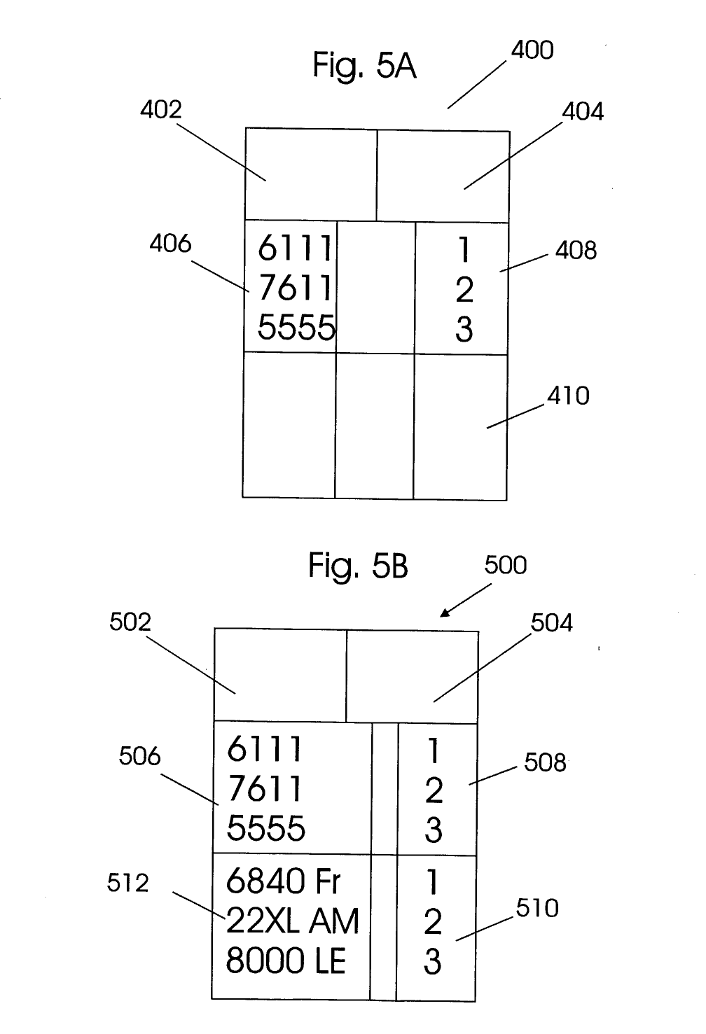

FIG. 5A shows a remote control 400 for someone sent by the monitoring center 200. The remote control 400 includes an on button 402 and a shut off button 404. The on button 402 turns on the remote control 400 and the shut off button 404 turns of the lights 20a and 20c of the vehicle 100, corresponding to the monitoring center 200. The remote control 400 includes a display 406 which shows the last four numbers of the vehicle identification numbers of the vehicles whose potential drivers failed a sobriety test. In this example vehicles with vehicle identification numbers having last four digits of “6111”, “7611”, and “5555” are vehicles that failed a sobriety test. The remote control includes a display 408 which shows the last four digits of a plurality of vehicle identification numbers of a corresponding plurality of vehicles which are disabled as a result of a potential driver failing a sobriety test in accordance with embodiments of the present invention. Currently a vehicle with identification number 6111 shown in FIG. 5A is the most recent call to the monitoring center 200 from a potential driver or driver who failed a sobriety test. An individual can press the shut off button 404 to deactivate lights 20a and 20c of the driver visual indication device 20 on the vehicle 100. The remote control 400 includes an emergency light 410.

FIG. 5B shows a remote control 500 for someone sent by the law enforcement center 300. The remote control 500 includes an on button 502 and a shut off button 504. The on button 502 turns on the remote control 500. The shut off button 504 can be used by a police officer sent by the law enforcement center 300, to shut off light 20b on the disabled vehicle 100. The remote control 500 includes a display 506 which shows the last four numbers of the vehicle identification numbers of the vehicles whose potential drivers attempted to drive after being warned not to, or after failing a sobriety test. In the example of FIG. 5B, “6111”, “76111”, and “5555” are the last four digits of vehicle identification numbers of three different vehicles whose potential drivers tried to restart their vehicle after being warned not to. The remote control includes a display 508 which shows the number of the incoming calls to the law enforcement center 200. Currently a vehicle with identification number 6111 shown in FIG. 5A is the most recent call to the law enforcement center 300 from a potential driver or driver who failed a sobriety test. An individual can press the shut off button 504 to deactivate light 20b of the driver visual indication device 20 on the vehicle 100. The remote control 500 includes a display 510 which shows the number of incoming calls that are from emergency or government agency vehicles that have been disabled due to the intoxication of a potential driver. The remote control device 500 also includes display 512 which in this example, displays the identification letters/numbers “6840 FR” “22XL AM” and “8000 LE”. In display 512 the letters “FR” stand for fire department, the letters “AM” stand for ambulance, and the letters “LE” stand for Law enforcement, such as police. In display 512, the first four digits and/or letters may be the last four digits of a vehicle identification number for a vehicle from a state or federal agency for handling emergencies such as police, fire, ambulance. The last two digits in each row of display 512, such as “FR”, “AM”, or “LE” provide information as to the particular agency. In this manner an individual sent by the law enforcement center 300 may be able to give priority to disabled vehicles from certain agencies.

The remote control 400 of FIG. 5A can be used to deactivate lights 20a and 20c. However, typically the lights 20a and 20c can be deactivated if the remote control 400 is about five feet away from the vehicle 100 or less. In one embodiment when the lights 20a and 20c (corresponding to a call to the monitoring center 200) are activated only the monitoring center 200 or a remote control device, such as 400, from someone sent to the vehicle 100 by the monitoring center 200, can deactivate the lights 20a and 20c. The remote control 500 of FIG. 5B can be used to shut off the light 20b. When the light 20b is activated (corresponding to a call to the law enforcement center 300) then, in one embodiment, only a remote control device, such as 500 from someone sent by the law enforcement center 300, such as a local policeman, can deactivate light 20b. Typically a single remote control would not be able to deactivate all three lights 20a, 20b, and 20c after they have been activated.

The processor 12 may cause the light 20d to be activated if thirty minutes after light 20a was activated no one comes to assist a driver who failed a sobriety test. Light 20d may also be called the emergency or ER light. Light 20d may automatically be activated by processor 12 thirty minutes after any one of lights 20a, 20b, or 20c is activated and know one from the monitoring center 200 or the law enforcement center 300 comes to assist the driver and to shut off the other lights 20a, 20b, or 20c. After the emergency light 20d is activated on the vehicle 100, an emergency light 410 and 510 on the monitoring center remote control 400 and the law enforcement center remote control 500 will also be activated. All the remote controls of agents from the monitoring center 400 may have their emergency light, similar to light 410, activated through for example telecommunications device 204, so that any such agent in the vicinity of the vehicle 100 can lend assistance. Similarly, all the remote controls of law enforcement agents from the law enforcement center 500 may have their emergency light, similar to light 510, activated through for example telecommunications device 304, so that any law enforcement agency in the vicinity of the vehicle 100 can lend assistance.

Widespread use of the present invention, allows our society to adopt a zero tolerance policy for the combination of alcohol and driving. This will save millions of lives. We have adopted a zero tolerance policy for drugs and alcohol in factories, government, offices, and the results are wonderful. It is also time for our law makers/policy makers to realize that drinking and driving do not mix. In order to eliminate alcohol related fatalities from accidents involving vehicles such as automobiles, motorcycles, airplanes, ships, or recreation boats, we should adopt a zero tolerance policy for drivers or operators of these vehicles. Use of the present invention in one or more embodiments, helps to implement such a zero tolerance policy.

The statistics of drivers in fatal crashes by blood alcohol concentration (BAC) speaks loudly for itself. These statistics will be a thing of the past if a zero tolerance policy is adopted for operators of vehicles. The purpose of the present invention is not to prevent people from drinking alcohol. Rather, it is designed to prevent alcohol induced accidents. This invention is designed to prevent any driver/operator of any vehicle (such as a car, airplane, ship, train, or boat) with any trace of alcohol from operating their vehicle or machinery.

With this invention, alcohol related fatalities in all areas of transportation and operation of machinery can be reduced and hopefully eliminated.

In the area of airplanes, since commercial airplanes are required to be running for a long time before take off, the pilots of commercial and non-commercial planes may have a specific room in the airport equipped with a sobriety test machine similar to apparatus 10 if FIG. 1, so that these pilots may have the sobriety test prior to boarding their respective airplanes. If the sobriety test is positive for alcohol then a pilot can be prevented from flying until the pilot sobers up. A supervisor may confirm the determination that the pilot is intoxicated.

When a vehicle, such as a automobile goes for annual inspection, it can be tested by someone or something tainted with alcohol to determine whether an apparatus, such as apparatus 10 is working.

Emergency vehicles and law enforcement vehicles may start without an initial sobriety test. However, the sobriety testing mechanism, such as with apparatus 10, may be activated at they travel from one point to another and if the driver tests positive the vehicle can be stopped.

The steering wheel 130 may be a power steering wheel which has been equipped with an alcohol sensitive material for a covering. The covering may be part of the BAC sensing device 14. The BAC sensing device 14 and/or the processor 12 may include a small display screen showing whether the results of the sobriety test are positive for alcohol or negative. A positive result may simply cause a screen of the BAC sensing device 14 to light one color, such as red, while a negative result may cause a screen of the BAC sensing device 14 to light another color, such as orange. The memory 16 may store the results of the sobriety tests performed by the BAC sensing device 14 and/or the processor 12. An ignition lock which may be part of ignition switch 25 or ignition device 24 may be locked when the sobriety test is failed and this may prevent the vehicle from starting.

Emergency vehicles and law enforcement center or agency vehicles may have a delayed sobriety test. I.e. due to the nature of their jobs, the sobriety test device, such as apparatus 10, may be activated only when the emergency vehicle and law enforcement driver is already on his/her way from Point A to Point B and if sobriety test device detects any trace of alcohol on the driver/officer, the vehicle will advise the driver to pull over and if he or she does not pull over, the vehicle will automatically come to a stop.

In one embodiment of the present invention, when any driver does not hold the steering wheel 130 as required, he/she will be advised by the processor 12 through the speaker device 18 that he/she needs to hold the steering wheel 130 much firmer.

To maintain the effectiveness and efficiency of the apparatus 10, when a BAC sensing device 14 comprised of a alcohol sensitive steering wheel cover is used, all replacement steering covers should be alcohol sensitive replacement power steering coverings. In an attempt to beat the apparatus 10, some drivers may purchase from the store non alcoholic sensitive replacement power steering coverings and use it to cover or put over the alcohol sensitive power steering covering. If that happens, the vehicle 100 will not start. Processor 12 will alert the potential driver that he/she is tampering with the device. If this potential driver needs a new replacement power steering cover or covering, he/she should get an alcohol sensitive replacement power steering covering.

Lights 20a and 20c may be replaced by one light for the monitoring center 200. Light 20b may be for the law enforcement center 300. Light 20d may be for emergency response. Once a vehicle, such as vehicle 100 moves from the regular class (lights 20a, 20b, or 20c) to the emergency class (light 20d) the last four numbers of that vehicle's vehicle identification number will be placed in an emergency column of a table in memory 206 of the monitoring center 200 and a table in memory 306 of the law enforcement center 300. A beeping sound can be emitted from the speaker device 18 until the light 20d is deactivated.

Five minutes after any vehicle goes to the emergency status and if neither someone from the monitoring center 200 or the law enforcement center 300 has arrived at the scene of the disabled vehicle then all four lights 20a-20d may be deactivated to save the vehicle's battery.

Two different states or jurisdictions may have two different blood alcohol content legal limits. For example, New Jersey may have a legal blood alcohol limit of 0.10 for driving a car or other vehicle, while New York state may have a legal blood alcohol limit of 0.20 for driving a car or other vehicle. In at least one embodiment of the present invention, the legal blood alcohol limit for driving in the state in which a vehicle is being driven, is compared to the individual's blood alcohol level. In at least one embodiment, the processor 12 determines what state the vehicle is currently in and compares that state's legal BAC limit with the BAC level of the driver. The legal limits of one or more states may be stored in memory 16. The processor 12 may determine what state a vehicle is in via the telecommunications device 22. The telecommunications device 22 may include a GPS (global positioning satellite) device including a GPS receiver for the determining the location of a vehicle.

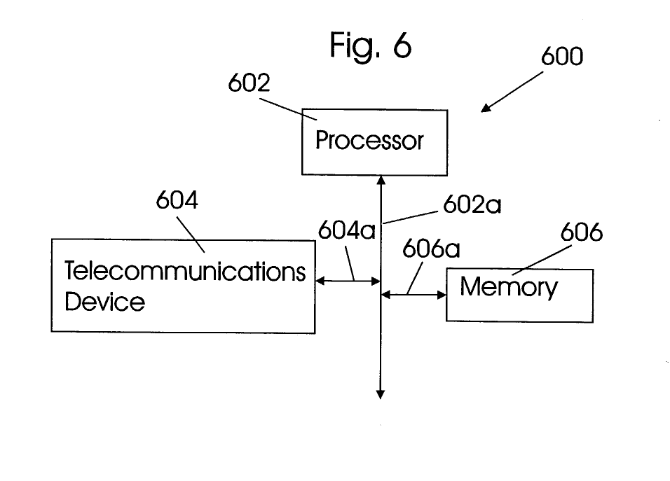

In at least one embodiment, to make the transition from one state, such as New York to New Jersey, each state may have a transmitter which may transmit the legal BAC limit for driving a vehicle. FIG. 6 shows an apparatus 600 comprising a processor 602, a telecommunications device 604, and a memory 606. The processor 602 may communicate with the telecommunications device 604 by communications links or busses 602a and 604a. The processor 602 may communicate with the memory 606 by communications links or busses 602a and 606a. The telecommunications device 604 may include a transmitter which may transmit the legal BAC limit for driving in a state. For example, the apparatus 600 may be located in New York and the telecommunications device 604 may transmit the legal BAC limit for driving in New York.

The BAC limit for a particular state may be stored in a memory 606, which may for example be a micro chip. The BAC limit may be transmitted from a location within the state, such as New York, near the border of a neighboring state, such as New Jersey and facing the neighboring state, such as facing New Jersey. In this manner, as soon as a vehicle leaves, for example, New Jersey, to enter for example, New York, the transmitter of the telecommunications device 604 for New York may transmit a signal providing New York's BAC legal limit for driving a vehicle.

In one embodiment, as soon as an out of state vehicle, such as from New Jersey, comes within one hundred yards of the neighboring state's transmitter or telecommunications device the incoming out of state vehicle will be able to receive the transmission. The driver of the vehicle, such as vehicle 100, can be warned by an alarm activated by processor 12, that the vehicle 100 has enterred a new state or jurisdiction with a different BAC limit from the state just exited. The alarm can be provided as an audible alarm through speaker device 18. The audible alarm can be for example, two low bell sounds. The new BAC limit can be displayed on the driver visual indicator device 20.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising
transmitting a signal providing data specifying a blood alcohol content limit for driving vehicles for a particular jurisdiction.

2. The method of claim 1 further comprising
receiving the signal at a vehicle;
determining a driver's blood alcohol content;
comparing the driver's blood alcohol content versus the particular jurisdiction's blood alcohol content limit for driving vehicles;
and causing operation of a vehicle to cease if the driver's blood alcohol content is greater than the particular jurisdiction's blood alcohol content limit for driving a vehicle.

3. The method of claim 1 further comprising
saving the data specifying the particular jurisdiction's blood alcohol content limit for driving vehicles in memory located at the vehicle.

4. The method of claim 1 wherein
the signal is transmitted near a border between the particular jurisdiction and another jurisdiction.

5. The method of claim 1 wherein
the particular jurisdiction is a state of the United States of America.

6. The method of claim 4 wherein
the particular jurisdiction and the another jurisdiction are two different states of the United States of America.

7. A method comprising
receiving a signal at a vehicle, wherein the signal includes data specifying a blood alcohol content limit for driving vehicles for a particular jurisdiction;
determining a driver's blood alcohol content;
comparing the driver's blood alcohol content versus the particular jurisdiction's blood alcohol content limit for driving vehicles;
and causing operation of a vehicle to cease if the driver's blood alcohol content is greater than the particular jurisdiction's blood alcohol content limit for driving a vehicle.

8. The method of claim 7 further comprising
displaying an indication of the blood alcohol content limit for the particular jurisdiction on a visual display indicator device of the vehicle.

9. The method of claim 7 further comprising
providing an audible warning to the driver when the signal is received.

10. An apparatus comprising
a device for receiving a signal, wherein the signal includes data specifying a blood alcohol content limit for driving vehicles for a particular jurisdiction;
a device for determining the blood alcohol content of a driver of a vehicle; and
a processor; and
wherein the processor compares the driver's blood alcohol content versus the particular jurisdiction's blood alcohol content limit for driving vehicles.

11. The apparatus of claim 10 wherein
the processor causes operation of the vehicle to cease if the driver's blood alcohol content is greater than the particular jurisdiction's blood alcohol content limit for driving a vehicle.

12. The apparatus of claim 10 further comprising
a memory; and
wherein the processor saves the data specifying the particular jurisdiction's blood alcohol content limit for driving vehicles in memory.

13. The apparatus of claim 10 wherein
the particular jurisdiction is a state of the United States of America.

14. The apparatus of claim 10 further comprising
a driver visual indicator device which displays an indication of the blood alcohol content limit for the particular jurisdiction.

15. The apparatus of claim 10 wherein
the processor provides an audible warning to the driver when the signal is received via a speaker device.
